(19) United States
(12) Patent Application Publication
(10) Pub. No.: US 2006/0179470 A1
(43) Pub. Date: Aug. 10, 2006

(54) INTERACTIVE PROMOTIONAL METHOD

(76) Inventors: George Johnson, Charlotte, NC (US); Chris Johnson, Charlotte, NC (US)

Correspondence Address: ADAMS EVANS P.A., 2180 TWO WACHOVIA CENTER, CHARLOTTE, NC, 28282, US

(21) Appl. No.: 11/307,433

(22) Filed: Feb. 7, 2006

Related U.S. Application Data
(60) Provisional application No. 60/650,924, filed on Feb. 8, 2005.

(51) Int. Cl. H04N 7/173; H04N 5/445; G06F 3/00; G06F 13/00; H04N 7/10; H04N 7/025; H04N 7/16

(52) U.S. Cl. 725/135; 725/31; 725/46; 725/110; 725/34

(57) ABSTRACT

A method of promoting an entity such as people, products, and property. The method includes the steps of receiving descriptive information about the entity, receiving a video segment of the entity, and assigning a common unique identifier to both the descriptive information and video segment. The method further including the steps of incorporating the unique identifier into the video segment, broadcasting the video segment, and making the descriptive information available to viewers of the video segment in an information portal in which the descriptive information is indexed by the unique identifier.

### TECHNICAL FIELD AND BACKGROUND OF THE INVENTION

This invention relates to a method for promotion of people or products and more specifically to a television show and information portal for promoting people, products, and property.

Currently there are many types of television shows and websites that promote products, people, or property. For example, “infomercials” are used for promoting and selling products to the general public. The “infomercial” is usually one-half hour long and has a host that describes and promotes the product being sold. These “infomercials” are expensive to produce, thereby limiting their availability to individuals.

Real estate agents often broadcast real estate television shows for showcasing properties they have for sale. The shows usually contain photos of various properties along with a narration describing the amenities associated with each property shown. The shows are limited to properties that the specific real estate agent is selling, preventing an individual from showing a property on the show.

Information services such as internet website have been used to sell products and property, and have also been used for online dating forums which allow individuals to post a picture and description of themselves in hopes of meeting someone with similar likes. Online dating forums usually require a monthly membership which allows an individual to post a picture and description of himself and then browse through photos and descriptions of other individuals. Once an individual finds someone that he or she likes, an email can be sent in an effort to start a conversation. This type of dating forum limits the exposure of an individual to a photo and written description and limits the number of individuals who can access the photos and descriptions through membership policies.

Dating television shows exist which match two people up for a date and then film their activities for the entertainment of the audience. Other television dating shows put a group of people in competition with each other for the chance to date a specific individual. Participation in these television dating shows is limited to a small group of individuals selected by the show's producers.

Accordingly, there is a need for a readily-accessible forum which allows individuals to promote themselves, their property, and their products.

### SUMMARY OF INVENTION

Therefore, it is an object of the invention to provide a method for allowing individuals to promote themselves, their products, and their property.

These and other objects of the present invention are achieved in the preferred embodiments disclosed below by providing a method of promoting an entity. The method includes the steps of receiving descriptive information about the entity, receiving a video segment of the entity, and assigning a common unique identifier to both the descriptive information and video segment. The method further includes the steps of incorporating the unique identifier into the video segment, broadcasting the video segment, and making the descriptive information available to viewers of the video segment in an information portal in which the descriptive information is indexed by the unique identifier.

According to another preferred embodiment of the invention, wherein the entity is selected from the group consisting of an individual, an object, and real property.

According to another preferred embodiment of the invention, wherein the entity is an individual.

According to another preferred embodiment of the invention, and further including the steps of establishing participation standards for the promotional method; receiving background information about the individual; and based on the background information, excluding the individual from the promotional method if the individual does not meet the participation standards.

According to another preferred embodiment of the invention, and further including the step of incorporating narration into the video segment.

According to another preferred embodiment of the invention, and further including the step of incorporating directions for accessing the information portal into the video segment.

According to another preferred embodiment of the invention, and further including the steps of establishing participation standards for the promotional method; prior to providing access to the information portal, receiving background information about the viewer; and based on the background information, excluding the viewer from access to the information portal if the viewer does not meet the participation standards.

According to another preferred embodiment of the invention, wherein the information portal allows individuals to communicate with each other through services selected from the group consisting of electronic bulletin boards, newsgroups, electronic mail, instant messaging, video casting, and telephone.

According to another preferred embodiment of the invention, wherein the information portal is selected from the group consisting of a website and a telephone service.

According to another preferred embodiment of the invention, a method of promoting an entity including the steps of receiving descriptive information about a plurality of entities, receiving a video segment of each of the entities, assigning a common unique identifier to both of the descriptive information and the video segment for each of the entities, and incorporating the unique identifiers into the respective video segments. The method further including the steps of editing each of the video segments into a television show, broadcasting the television show, making the descriptive information available to viewers of the video segments in an information portal indexed by the unique identifiers.

According to another preferred embodiment of the invention, and further including the step of establishing participation standards for the promotional method; receiving background information for each of the entities; and based on the background information, excluding the entities from the promotional method if the entity does not meet the participation standards.

According to another preferred embodiment of the invention, and further including the step of advertising the television show, the step of advertising includes the steps of identifying a service provider which concurrently distributes a plurality of television programs to viewers; obtaining a common time slot from the service provider associated with the plurality of programs; and broadcasting a commercial during the time slot, the commercial directing viewers to the television show.

According to another preferred embodiment of the invention, a method of facilitating interpersonal relationships including the steps of providing a promotional platform including a television show and an information portal, receiving personal descriptive information about a plurality of participants, receiving a video segment of each of the participants, and assigning a common unique identifier to both of the descriptive information and video segment for each of the participants. The method further including the steps of incorporating the unique identifier into the respective video segments, broadcasting the video segments on the television show, and making the descriptive information available to viewers of the television show through the information portal via the unique identifiers.

According to another preferred embodiment of the invention, and further including the steps of establishing participation standards for the facilitation of interpersonal relationships; prior to providing access to the information portal, receiving background information about the viewer; and based on the background information, excluding the viewer from access to the information portal if the viewer does not meet the participation standards.

According to another preferred embodiment of the invention, wherein the information portal allows participants to communicate with each other through services selected from the group consisting of electronic bulletin boards, newsgroups, electronic mail, instant messaging, video casting, and telephone.

### BRIEF DESCRIPTION OF THE DRAWINGS

The invention may be best understood by reference to the following description taken in conjunction with the accompanying drawings, in which:

FIG. 1 is a schematic diagram of a promotional method according to an embodiment of the invention;

FIG. 2 is a schematic view of the steps taken by an individual using the method of FIG. 1;

FIG. 3 is a schematic view of the steps taken by a viewer using the method of FIG. 1; and

FIG. 4 is a schematic view of a method of advertising a television show according to an embodiment of the invention.

### DESCRIPTION OF THE PREFERRED EMBODIMENT AND BEST MODE

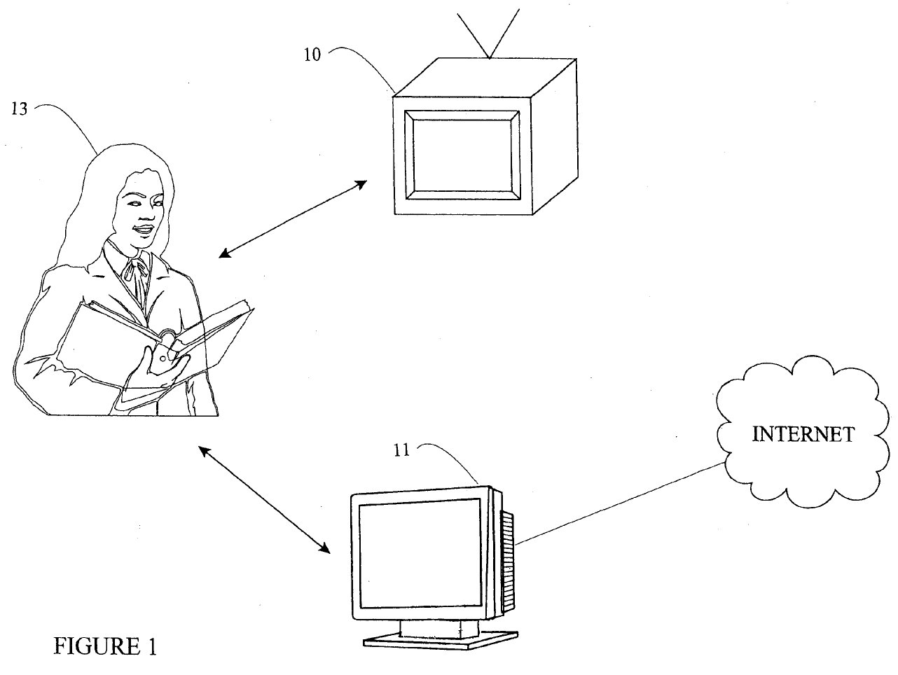

Referring now specifically to the drawings, a promotional method according to an embodiment of the present invention is illustrated in FIG. 1. The method uses a television show 10 and an information portal 11 cooperating to provide a medium where individuals 13 can promote themselves, their products, or their property. The television show 10 can be distributed locally and nationally, for example through broadcast, satellite, or cable. The information portal 11 provides users with remote access to various types of services and information such as electronic bulletin boards, newsgroups, etc. As illustrated, the information portal 11 is a website, but may also be a dial-up service accessed by a telephone or any other suitable service.

The television show 10 and related information portal 11 can be directed to various purposes such as a dating service for allowing individuals to meet each other, a job-related service which allows individuals to distribute resumes for viewing by potential employers, a real estate service through which individuals can sell their home, a product-related service where an individual can sell candy, bicycles, etc., or any other related service which would benefit from the medium.

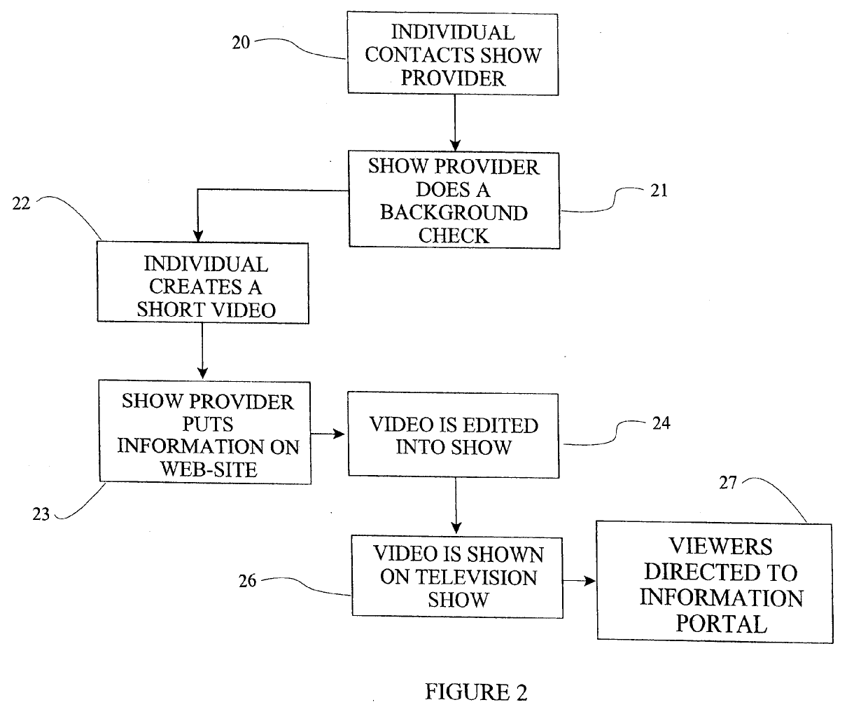

Each of the above services are performed using substantially the same method, thus, for clarity only a dating service will be described in detail. As shown in FIG. 2, an individual who desires to be a part of the dating service contacts the provider of the show 10 at block 20 and submits a membership application, allowing the individual 13 access to the television show and information portal. The provider may then optionally perform a background check of the individual 13 at block 21 to verify that the individual has been completely truthful on the application and to verify that the individual 13 is not married and has not been convicted of any crimes, specifically sex-related crimes. Once the show provider has performed a background check, the individual 13 is contacted and informed that their application has been accepted and is instructed to create a short video at block 22 (e.g. 30 seconds to 1 minute) describing themselves and the type of person that the individual 13 is looking to date. Additionally, the individual 13 is given an identification number which is used on the information portal 11 and television show 10 to protect the identity of the individual 13 and prevent others from contacting the individual 13 without the individual's consent. Once the video is received, the show provider puts the video, photos, or other literature on the information portal 11 at block 23 for other members to view.

The video is given a number based on when the video is received to determine on which episode of the television show the video will air. The show provider then informs the individual 13 of the episode and date of the television show so that the individual 13 may watch the show. The video is edited and included in the designated episode of the television show 10 at block 24. The host of the show narrates the entire show at block 26 and introduces each of the videos using the identification number given to each individual. After each video has aired the host then directs the viewers to the information portal 11 at block 27 where additional information such as height and weight can be obtained for the individual in the video. The show could be produced on a conventional set using props or on a virtual set which is produced on a computer for preparing the show for broadcast. Additionally, each show can be tailored for a particular audience based on race, gender, religion, and other suitable categories.

The information portal 11 allows the viewers to browse through all of the individuals that were on the television show 10 or to go directly to a specific individual using the identification number. In addition to allowing the viewer find a specific individual by identification number, the information portal 11 allows a viewer to search for a specific type of individuals by narrowing the search using parameters such as height, weight, race, eye color, hair color, hobbies, and any other related parameter. The information portal also provides an environment where individuals can communicate with each other individually or with a group in a “chat room.”

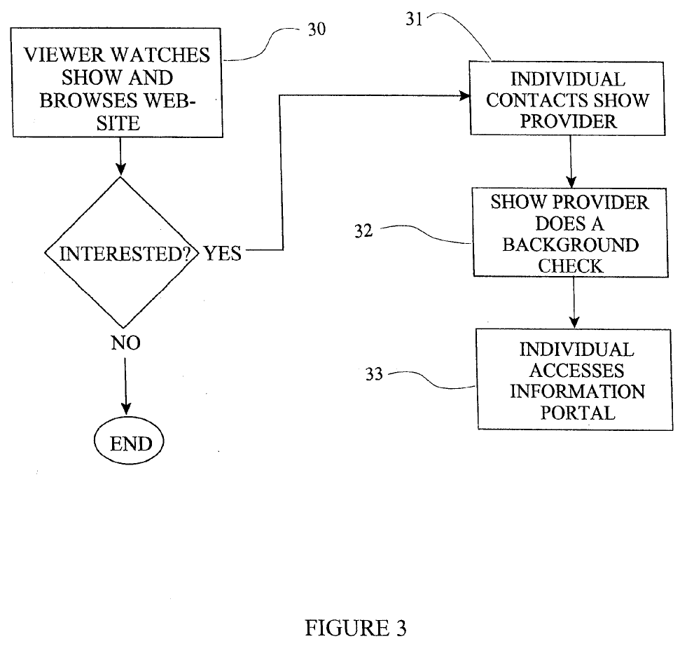

As illustrated in FIG. 3, if the viewer decides to contact one of the individuals at block 30, the viewer fills out a membership application at block 31 allowing the show provider to perform a background check at block 32. Once the application is approved, the viewer can then contact any of the individuals the viewer saw on the television show 10 or any other individual on the information portal 11 via email, instant messaging, video casting or other appropriate messaging medium at block 33. The viewer may also participate in the dating service as described in FIG. 2 above and produce a video for the television show. Throughout this whole process the individual's identity and personal information is kept confidential and is only accessible through the consent of the individual.

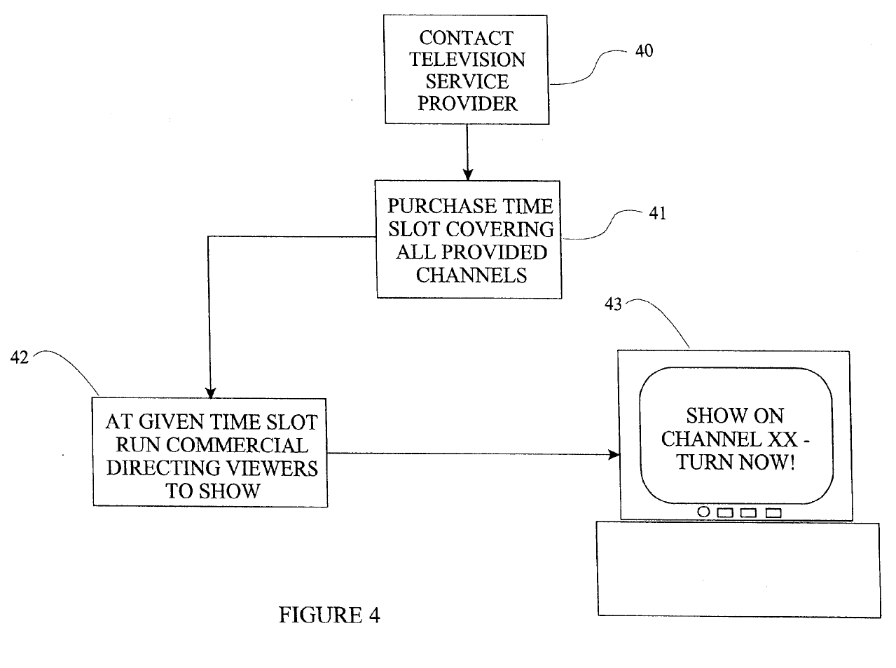

Referring now to FIG. 4, the show may optionally be advertised on multiple television channels during the shows broadcast time in an effort to connect with individuals who may view several different channels for brief periods of time, commonly referred to as “channel surfers”, as well as those people who watch one specific channel the entire time. This is done by contacting the television service provider at block 40 for the area where the broadcast is taking place and buying a time slot at block 41 covering multiple channels, and preferably all channels provided by the service provider. A commercial or message describing the show will then be run at block 42 during that time slot, directing all viewers to turn to the channel at block 43 where the show is being broadcast.

A method of promoting people, products, and property is described above. Various details of the invention may be changed without departing from its scope. Furthermore, the foregoing description of the preferred embodiment of the invention and the best mode of practicing the invention are provided for the purpose of illustration only and not for the purpose of limitation.

What is claimed is:

1. A method of promoting an entity, comprising the steps of:
(a) receiving descriptive information about the entity;
(b) receiving a video segment of the entity;
(c) assigning a common unique identifier to both the descriptive information and video segment;
(d) incorporating the unique identifier into the video segment;
(e) broadcasting the video segment;
(f) making the descriptive information available to viewers of the video segment in an information portal in which the descriptive information is indexed by the unique identifier.

2. The method according to claim 1, wherein the entity is selected from the group consisting of an individual, an object, and real property.

3. The method according to claim 1, wherein the entity is an individual.

4. The method according to claim 3, and further including the steps of:
(a) establishing participation standards for the promotional method;
(b) receiving background information about the individual; and
(c) based on the background information, excluding the individual from the promotional method if the individual does not meet the participation standards.

5. The method according to claim 1, and further including the step of incorporating narration into the video segment.

6. The method according to claim 1, and further including the step of incorporating directions for accessing the information portal into the video segment.

7. The method according to claim 1, and further including the steps of:
(a) establishing participation standards for the promotional method;
(b) prior to providing access to the information portal, receiving background information about the viewer; and
(c) based on the background information, excluding the viewer from access to the information portal if the viewer does not meet the participation standards.

8. The method according to claim 1, wherein the information portal allows individuals to communicate with each other through services selected from the group consisting of electronic bulletin boards, newsgroups, electronic mail, instant messaging, video casting, and telephone.

9. The method according to claim 1, wherein the information portal is selected from the group consisting of a website and a telephone service.

10. A method of promoting an entity, comprising the steps of:
(a) receiving descriptive information about a plurality of entities;
(b) receiving a video segment of each of the entities;
(c) assigning a common unique identifier to both of the descriptive information and the video segment for each of the entities;
(d) incorporating the unique identifiers into the respective video segments;
(e) editing each of the video segments into a television show;
(f) broadcasting the television show;
(g) making the descriptive information available to viewers of the video segments in an information portal indexed by the unique identifiers.

11. The method according to claim 10, and further including the step of:
(a) establishing participation standards for the promotional method;
(b) receiving background information for each of the entities; and
(c) based on the background information, excluding the entities from the promotional method if the entity does not meet the participation standards.

12. The method according to claim 10, and further including the step of incorporating narration into the video segment.

13. The method according to claim 10, and further including the steps of:
(a) establishing participation standards for the promotional method;
(b) prior to providing access to the information portal, receiving background information about the viewer; and
(c) based on the background information, excluding the viewer from access to the information portal if the viewer does not meet the participation standards.

14. The method according to claim 10, wherein the information portal allows individuals to communicate with each other through services selected from the group consisting of electronic bulletin boards, newsgroups, electronic mail, instant messaging, video casting, and telephone.

15. The method according to claim 10, and further including the step of advertising the television show, the step of advertising comprising the steps of:
(a) identifying a service provider which concurrently distributes a plurality of television programs to viewers;
(b) obtaining a common time slot from the service provider associated with the plurality of programs; and
(c) broadcasting a commercial during the time slot, the commercial directing viewers to the television show.

16. A method of facilitating interpersonal relationships, comprising the steps of:
(a) providing a promotional platform, comprising:
(i) a television show; and
(ii) an information portal;
(b) receiving personal descriptive information about a plurality of participants;
(c) receiving a video segment of each of the participants;
(d) assigning a common unique identifier to both of the descriptive information and video segment for each of the participants;
(e) incorporating the unique identifier into the respective video segments;
(f) broadcasting the video segments on the television show; and
(g) making the descriptive information available to viewers of the television show through the information portal, wherein the descriptive information is indexed by the unique identifiers.

17. The method according to claim 16, and further including the step of incorporating narration into the television show.

18. The method according to claim 16, and further including the steps of:
(a) establishing participation standards for the facilitation of interpersonal relationships;
(b) prior to providing access to the information portal, receiving background information about the viewer; and
(c) based on the background information, excluding the viewer from access to the information portal if the viewer does not meet the participation standards.

19. The method according to claim 16, wherein the information portal allows participants to communicate with each other through services selected from the group consisting of electronic bulletin boards, newsgroups, electronic mail, instant messaging, video casting, and telephone.

20. The method according to claim 16, and further including the step of advertising the television show, the step of advertising comprising the steps of:
(a) identifying a service provider which concurrently distributes a plurality of television programs to viewers;
(b) obtaining a common time slot from the service provider associated with the plurality of programs; and
(c) broadcasting a commercial during the time slot, the commercial directing viewers to the television show.
